(19) United States
(12) Patent Application Publication
(10) Pub. No.: US 2011/0312208 A1
(43) Pub. Date: Dec. 22, 2011

(54) PUSH-IN CONNECTOR FOR ACCEPTING THE END OF A RIGID CONDUCTOR

(76) Inventor: Ralph Hoppmann, Bad Oeynhausen (DE)

(21) Appl. No.: 13/145,121

(22) PCT Filed: Sep. 17, 2010
(86) PCT No.: PCT/EP2010/005720

§ 371 Date: Sep. 7, 2011

(30) Foreign Application Priority Data
Oct. 22, 2009 (DE) 10 2009 050 366.8

(51) Int. Cl. H01R 13/62

(52) U.S. Cl. 439/370

(57) ABSTRACT

The present invention pertains to a push-in connector for accepting a rigid end 10 of a conductor. The push-in connector comprises a stop 20 for arresting the end of the conductor in the push-in connector. A spring element 30 is designed to push the end of the conductor introduced into the push-in connector against the stop in such a way that the end of the conductor is arrested nonpositively in the push-in connector. The push-in connector comprises a tipping element 40 for defining a tipping axis. The tipping element 40 is arranged in such a way that the spring element 30 generates a torque around the tipping axis 50 on the introduced end 10 of the conductor so that the end 10 of the conductor is pressed against the stop 20.

The present invention pertains to a push-in connector for accepting a rigid end of a conductor.

Connecting terminals are used especially in the electrical engineering field to connect wires, strands, or cables in a detachable manner. Permanent and reliable contact is to be guaranteed in the connected state. This is achieved by the use of mechanical means (a screw or spring, for example) to hold the connected conductor in a conductive body.

Many different types of connecting terminals are known. Various types of spring-type connecting terminals are also known, especially leg spring terminals. These terminals usually have a component which conducts the current and a spring which cooperates with that component.

The contact wall of these terminals, however, extends below or above the projecting edge; as a result, the force of the spring acts between at least two contact points, which means that the contact force is divided. Terminals in which the conductor passes all the way through are also known. These connecting terminals are designed in such a way that the effective spring force acts on a point more-or-less opposite the contact edge, so that the available spring force is almost the same as the contact force. EP 1 391 965 A1 describes a corresponding spring-loaded terminal for an electrical conductor, which comprises a bus bar piece with a rectangular pass-through opening, into which the end of the clamping leg of a leaf spring projects in such a way that the end of the clamping leg cooperates with an inner wall surface of the collar of the pass-through opening to form a clamping point for an electrical conductor. It is proposed in this publication that the surface of the inside wall of the collar be designed with a transverse edge. In order to improve the electrical contact, the clamping leg of the leaf spring is also dimensioned and shaped in such a way that, when the clamping edge at the end of the clamping leg is in the position where it is clamping the electrical conductor, it is more-or-less opposite the transverse edge present on the surface of the inner wall of the collar.

The disadvantage of the known connecting terminals is that the strongest possible spring force is required to provide a reliable clamping connection. The stronger the spring force, however, the greater the difficulty of inserting the conductor into the connector.

It is therefore the goal of the present invention to provide a push-in connector for accepting the rigid end of a conductor which makes it possible for the end of the conductor which has been introduced into the connector to be held in place reliably and for reliable electrical contact to be established, wherein the end of the conductor can be inserted as easily as possible.

The goal is accomplished by a push-in connector for accepting a rigid end of a conductor according to the attached claim 1. The inventive push-in connector comprises a stop for arresting the end of the conductor which has been introduced into the push-in connector. According to the invention, a spring element is provided, which presses the end of the conductor which has been introduced into the push-in connector against the stop in such a way that this end is arrested nonpositively in the push-in connector. The push-in connector comprises a tipping element, which defines a tipping axis, wherein the tipping element is arranged in such a way that the spring element generates a torque around the tipping axis on the introduced end of the conductor and thus presses this end against the stop. The tipping element can be used suitably to define the strength of the contact force by which the end of the conductor is pressed against the stop. The law of levers is used for this purpose. A strong contact force against the stop can be generated by a relatively weak restoring force of the spring element. This improves the nonpositive connection between the conductor end and the stop for holding the conductor end in place in the push-in connector. At the same time, the end of the conductor can be released by rotating it against the spring element, which makes it easier to remove or insert the end of the conductor. The tipping axis extends transversely to the axial direction of the end of the conductor.

The distance between the stop and the tipping axis is preferably shorter than the distance between the tipping axis and the point at which the force of the spring acts on the end of the conductor. The distance to the action point of the spring element corresponds to the lever length of the spring element. The greater the length of this lever in comparison to the lever of the stop, the greater the force difference—perpendicular to the tipping axis when in the state of equilibrium—between the restoring force of the spring and the stop force, with the result that, in the arrested state, the contact force acting on the stop is greater than the spring force by which the spring element presses against the end of the conductor.

According to another preferred embodiment of the present invention, a current bar conducts the electrical current from the end of the conductor. The stop, in the arrested state of the conductor, establishes electrical contact between the introduced end of the conductor and the current bar. Thus the stop is able to provide both a nonpositive connection for arresting the end of the conductor and electrical contact. It is also advantageous with respect to the nonpositive connection for two metallic surfaces to act on each other, i.e., surfaces which are not deformable, in contrast to the plastic housing of the push-in connector or the sheath around the conductor.

A second stop is preferably also provided, which, in the arrested state of the end of the conductor, generates additional torque around the tipping axis. The second stop is preferably located at the end of the conductor as far away as possible from the tipping axis. The second stop is preferably releasable, so that the end of the conductor can be removed from the push-in connector. For this purpose, the second stop is pivoted or pushed away from the introduced end of the conductor, so that only the spring element is left to press against the conductor end. By rotation of the end of the conductor against the torque generated by the spring element, the conductor end can then be released from the first stop and removed from the push-in connector. This procedure can be carried out in reverse to introduce the conductor end into the push-in connector. First, the end of the conductor is inserted into the push-in connector and arrested by the first stop alone. Then the second stop is pivoted or pushed against the end of the conductor and locked in place to support the torque by which the spring element arrests the conductor. This prevents the end of the conductor from being released unintentionally if it were to be pivoted slightly against the force of the spring. The second stop also preferably establishes a second point of electrical contact between the introduced end of the conductor and the current bar.

Exemplary embodiments of the present invention are described below with reference to the attached figures:

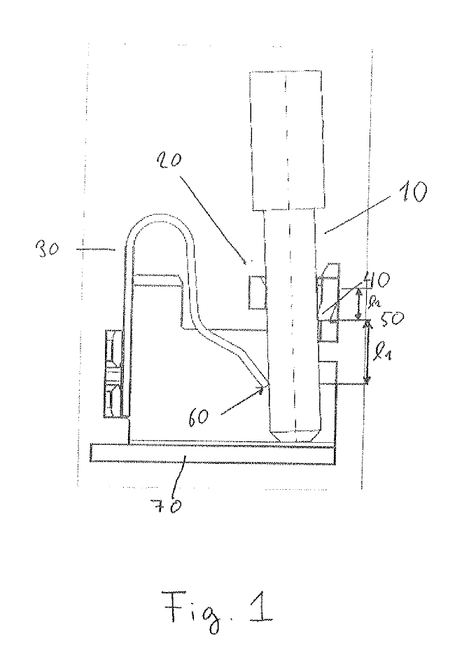

FIG. 1 shows a cross-sectional view of a push-in connector according to a first exemplary embodiment of the present invention;

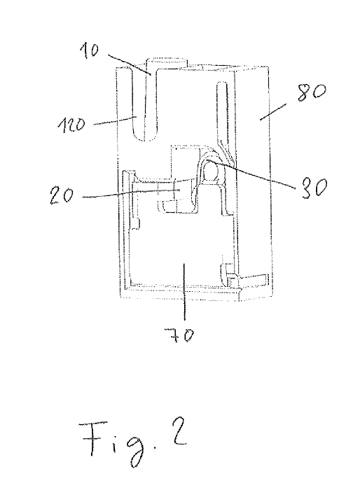

FIG. 2 shows a perspective view of the push-in connector according to the first exemplary embodiment as shown in FIG. 1;

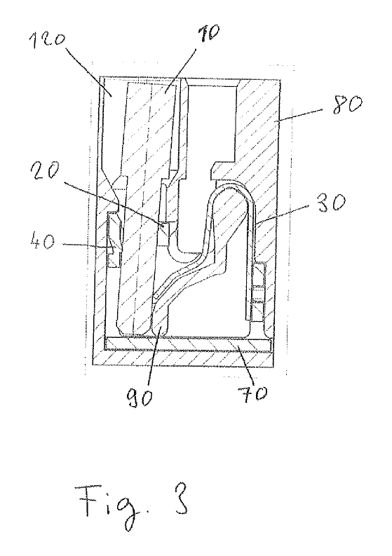

FIG. 3 shows a cross-sectional view of the push-in connector according to a second exemplary embodiment of the present invention; and

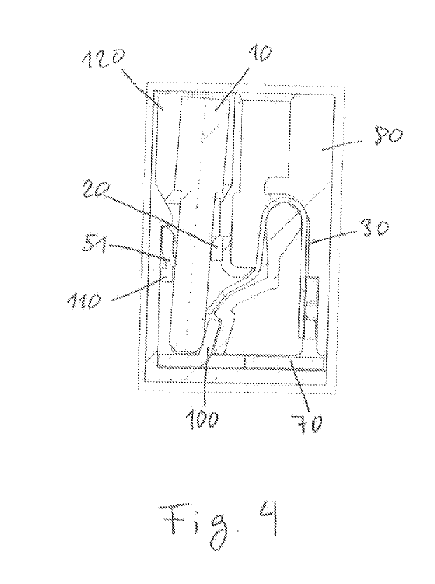

FIG. 4 shows a cross-sectional view of a third exemplary embodiment of the present invention.

The cross-sectional view of the first exemplary embodiment shown in FIG. 1 illustrates the way in which the present invention works. FIG. 1 shows the push-in connector after the end 10 of the conductor has been introduced into it. A stop 20 is provided, against which the end 10 of the conductor rests in nonpositive fashion. A spring 30 presses the end 10 of the conductor against a tipping element, as a result of which a torque is created, which rotates the end of the conductor around a tipping axis. As a result, the end of the conductor is pressed against the stop 20.

The end of the conductor is essentially cylindrical. It has a sheath of flexible plastic, from which a rigid, conductive end sleeve of the conductor projects. The longitudinal axis of the end 10 is shown in an essentially vertical position in FIG. 1. The stop 20 is designed so that the largest wire end sleeve and/or the largest end 10 of a rigid conductor to be used for the intended terminal cross section and/or the largest intended plug gauge can be introduced. This stop 20 is advantageously formed as part of current bar 70.

The stop 20 is located on one side of the end of the conductor. The contact surface between the stop 20 and the end sleeve of the conductor end 10 and the perpendicular force generated by the spring 30 on the stop 20 produce a large amount of static friction. As a result of this static friction, the end of the conductor is held firmly in place in the push-in connector. Characteristic of the present invention is that, in contrast to the prior art, the stop 20 is not arranged on the side of the end 10 of the conductor opposite the spring element 30. Instead, both the spring element 30 and the stop are located on the same side of the introduced conductor end 10. A tipping element 40 ensures that the force exerted by the spring element 30 is transmitted to the contact surface. The tipping element 40 is designed essentially as a projection, which defines a tipping axis 50, around which the introduced end 10 of the conductor can pivot.

In the state of equilibrium after the end of the conductor has been arrested, the torque generated by the spring element 30 is exactly as strong as the opposing torque generated by the stop 20. The following is therefore true:

F_{spring}*l₁=Fₛₜₒₚ*l₂ (1)

F_{spring} is the spring force perpendicular to the tipping axis 50; l₁ is the distance between the point at which the spring element acts on the end 10 of the conductor and the tipping axis 50; Fₛₜₒₚ is the restoring force of the stop perpendicular to the tipping axis 50; and l₂ is the distance between the stop 20 and the tipping axis 50.

The goal of the invention is to optimize the nonpositive connection between the stop 20 and the end 10 of the conductor. It can be seen from Equation (1) that, the shorter the distance l₂ between the stop and the tipping axis, the greater the stop force Fₛₜₒₚ. Increasing the distance l₁ between the point at which the spring force acts on the conductor end 10 and the tipping axis 50 also increases the stop force Fₛₜₒₚ. For this reason, it is preferable to place the tipping axis 50 closer to the stop 20 than to the action point of the spring 30. As a result, an especially strong stop force is generated by a comparatively weak spring force. The greater the stop force, the better the nonpositive connection between the stop 20 and the end 10 of the conductor.

Conventionally, a strong stop force has meant that the stronger the nonpositive connection, the greater the force which must be exerted to insert and remove the end of the conductor. The exemplary embodiment, however, shows that the end of the conductor can be released relatively easily. For this purpose, it is necessary merely to rotate the end 10 of the conductor around the tipping axis 50 in such a way that it no longer rests against the stop. The law of levers applies here again. The farther away from the tipping axis one grips the end 10 of the conductor, the smaller the amount of force required to release it. As soon as the end 10 of the conductor has been moved away from the stop, it can be pulled out effortlessly. Nevertheless, the spring and the tipping element still produce a certain static friction, which opposes the removal or introduction of the end of the conductor. But because both the tipping element and the spring element have only a relatively small contact surface with the end of the conductor, the friction surface is very small. Both the static friction and the sliding friction between the end of the conductor and the push-in connector are therefore minimized. Accordingly, it is very easy to insert and the remove the end of the conductor.

The push-in connector according to FIG. 1, furthermore, has a current bar 70 for carrying away the electrical current flowing through the end 10 of the conductor. FIG. 2 shows a perspective view of the push-in connector according to the first exemplary embodiment. It can be seen that the end of the conductor is introduced into a funnel 120, which is formed by a housing 80. The cable funnel 120 is preferably designed to be large enough that the spring element will not press the end of the conductor against the cable funnel. The stop alone is supposed to oppose the torque of the spring element, so as to produce the strongest possible nonpositive connection. The housing 80 is preferably made of insulating plastic. The current bar is let into the housing 80; it serves to carry the electrical current from the end 10 of the conductor to another conductor (not shown).

The stop 20 is designed as part of the current bar 70. It therefore serves not only to arrest the end 10 of the conductor mechanically but also to connect the end 10 of the conductor electrically. Designing the stop as part of the current bar offers the advantage that the metallic sleeve around the end 10 of the conductor rests on the metallic stop. The elastically deformable sheath around the conductor would become deformed under the force of contact. The flow of the plastic material, however, can affect, specifically reduce, the contact force between the stop 20 and the end 10 of the conductor, which is disadvantageous, because it is desirable for the contact force to be predictable so to ensure that the end of the conductor is held securely in place.

FIG. 3 shows a cross-sectional view of the push-in connector according to a second exemplary embodiment of the present invention. The features of the push-in connector according to FIG. 3 which are the same as the features of the first exemplary embodiment are designated by the same reference numbers. The push-in connector according to the second exemplary embodiment also has a stop 20, a spring element 30, and a tipping element 40. The end of the conductor is introduced into the funnel of the housing 80 and locked in place in the push-in connector.

The force of the spring acts on the end of the conductor and is redirected via the tipping element 40 onto the stop in such a way that a nonpositive connection is generated between the stop 20 and the end of the conductor. This nonpositive connection prevents the end 10 of the conductor from being pulled easily out of the push-in connector 10. The friction between the stop 20 and the end 10 of the conductor opposes the movement of the end of the conductor along the stop. If, however, the end of the conductor is released from the stop by rotating it slightly against the spring element 30, the end of the conductor can then be pulled out of the funnel 120. So that the nonpositive connection between the end 10 of the conductor and the stop 20 is not released in this way unintentionally, a second stop, namely, a housing stop 90, is provided in FIG. 3. This prevents the end of the conductor from moving under the action of external influences in the direction opposite the torque generated by the spring element, which would have the effect of releasing the end of the conductor. The housing stop 90 is preferably designed to be releasable, so that, after the conductor has been released from the housing stop 90, the end 10 can be easily removed again or introduced. It is also advantageous for the conductor to be guided or retained laterally by one or more guide elements, so that any rotation of the conductor toward the tipping axis is avoided. These guide elements can comprise lateral surfaces and/or a groove, in which the conductor is held laterally in place. A lateral guide can also be realised by the cable funnel 120, for example.

FIG. 4 shows a cross section through a third exemplary embodiment of the push-in connector of the present invention. The features corresponding to the exemplary embodiment of FIG. 3 are designated by the same reference numbers. In contrast to the second exemplary embodiment, the push-in connector according to FIG. 4 has an additional stop 100, which is a component of the current bar 70. This provides an additional electrical contact point for the flow of current through the conductor 10. This stop preferably works together with the torque generated by the spring element 30 on the end of the conductor, so that the end of the conductor cannot be released from its arrested position by mistake. Finally, the arresting action of the current bar stop 100 can be released, so that the end 10 of the conductor can be removed or introduced relatively easily when necessary.

For flexible conductors and for small rigid ones, a contact surface 110 is provided underneath the contact rib 51, which defines the tipping axis. This contact surface is set back somewhat from the contact rib 51 in the direction toward the end of the conductor so that it does not interfere with the tipping moment exerted on the ends 10 of larger rigid or multi-wire conductors.

In all of the exemplary embodiments shown here, the stop 20 is arranged above the tipping element 50. The point at which the spring element 30 acts on the end 10 of the conductor is below the tipping element 50. As an equivalent to this there is the possibility of designing the push-in connector in such a way that the spring element 30 acts on the conductor at a point above the tipping element 50. In this case, a stop will be installed in the lower part of the housing or extending from the current bar to take over the function of arresting the end of the conductor by means of a nonpositive connection. A design of this type offers the advantage that a force acting on the conductor supports the tipping moment.

### LIST OF REFERENCE NUMBERS

l₁ distance between the tipping axis 50 and the action point 60 of the spring 30
l₂ distance between the tipping axis 50 and the stop 20
10 end of the conductor
20 stop
30 spring element
40 tipping element
50 tipping axis
51 contact rib
60 action point of the spring element 30
70 current bar
80 housing
90 housing stop
100 current bar stop
110 contact surface
120 cable funnel

1. A push-in connector for accepting a rigid end (10) of a conductor with
a stop (20) for arresting the end of the conductor in the push-in connector; and
a spring element (30), which is designed to press the end (10) of the conductor which has been introduced into the push-in connector against the stop (20) in such a way that the end (10) of the conductor is arrested non-positively in the push-in connector,
characterized by
a tipping element (40) for defining a tipping axis, wherein the tipping element (40) is arranged in such a way that the spring element (30) generates a torque around the tipping axis (50) on the introduced end (10) of the conductor, so that the end (10) is pressed against the stop (20).

2. A push-in connector according to claim 1, characterized in that the distance between the stop and the tipping axis is shorter than a distance between the tipping axis and the point where the force of the spring acts on the end of the conductor, so that, in the arrested state of the conductor, the contact force acting on the stop is greater than the force by which the spring element presses against the end of the conductor.

3. A push-in connector according to claim 1 or claim 2, characterized by a current bar for conducting electrical current from the end of the conductor, wherein the stop, when the conductor is in the arrested state, provides electrical contact between the introduced end of the conductor and the current bar.

4. A push-in connector according to one of the preceding claims, characterized by a second stop (90, 100), which is designed to generate additional torque around the tipping axis in the arrested state of the end (10) of the conductor.

5. A push-in connector according to claim 4, characterized in that the second stop provides additional electrical contact between the introduced end of the conductor and the current bar.
